(19) United States
(12) Patent Application Publication
(10) Pub. No.: US 2007/0189135 A1
(43) Pub. Date: Aug. 16, 2007

(54) Optical disc apparatus and disc management information acquisition method

(75) Inventors: Eijiro Tazawa, Tokyo (JP); Atsushi Fuchiwaki, Yokohama (JP); Taku Hoshizawa, Kawasaki (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignees: Hitachi, Ltd., Tokyo (JP); Hitachi-LG Data Storage, Inc., Tokyo (JP)

(21) Appl. No.: 11/529,468

(22) Filed: Sep. 27, 2006

(30) Foreign Application Priority Data
Feb. 16, 2006 (JP) 2006-039156

(51) Int. Cl. G11B 20/10

(52) U.S. Cl. 369/47.14; 369/53.16

(57) ABSTRACT

The present invention provides a method or an apparatus for recording data additionally by acquiring replacement data easily even when the latest disc management information cannot be read out of the disc. When updating TDMS (Temporary Disc Management Structure), an update reason of a corresponding TDMS and a TDDS (Temporary Disc Definition Structure) start address in a previously recorded TDMS are recorded in disc management information as additional information. If the latest TDMS cannot be read out of the disc but the additional information can be read out, the additional information are referred to determine the latest LRA for use in additional data recording on the disc.

### CLAIM OF PRIORITY

The present application claims priority from Japanese application serial no. JP 2006-039156, filed on Feb. 16, 2006, the content of which is hereby incorporated by reference into this application.

### BACKGROUND OF THE INVENTION

(1) Field of the Invention

The present invention relates to an optical disc apparatus recording data onto a write-once optical disc recording medium and a disc management information acquisition method used therefor.

(2) Description of the Related Art

To record new data onto a write-once optical disc medium, a recording address of the data to be recorded is to be determined by referring to disc management information (the latest recording address information and/or the latest defect list) recorded in a specific management region, such as, on an inner circumference, of the disc. When additional recording is finished, the latest management information for the additionally recorded data is to be updated and recorded onto the optical disc medium to use it as reference later.

Japanese Patent Laid-Open Publication No. 2005-56542 discloses a write-once optical disc which permits a user to layout management information and to search for the latest management information. According to the Publication, the latest defect list (DFL) and the latest Disc Management Structure (DDS) can be easily searched by locating them in a recorded defect management area contiguous to the boundary of a recorded defect management area and an unrecorded defect management area.

In addition, White Paper Blu-ray Disc Format (1.B Physical Format specifications for BD-R, August, 2004, Blu-ray Disc Founders) discloses the allocation of disc management information for a write-once high capacity Blu-ray disc (BD-R). The literature also provides details on all types of management information including TDMA (Temporary Disc Management Area), TDMS (Temporary Disc Management Structure), TDDS (Temporary Disc Definition Structure), SRRI (Sequential Recording Range Information) and TDFL (Temporary Defect List).

### SUMMARY OF THE INVENTION

A position (address) on the write-once optical disc to additionally record data is to be determined with reference to the latest disc management information. Therefore, if, for some reason, the latest management information cannot be read out, an additional data recording operation cannot be executed. Although search for an additionally recordable address within a non-recorded area can be done by checking all areas on the disc thoroughly to find out whether they are already recorded or not without referring to the disc management information, this is a time-consuming and unpractical job.

It is, therefore, an object of the present invention to provide an optical disc apparatus and a disc management information acquisition method, which although impossible to read out the latest disc management information of a write-once optical disc before being finalized, easily acquire replaceable information and carry out an additional recording operation.

In order to solve the above-mentioned problem, there is provided an optical disc apparatus for use in additional data recording on a write-once optical disc, the apparatus including: a spindle motor which rotates the optical disc; a pickup which irradiates a laser beam onto the optical disc, reads out disc management information, and thereby executes an additional recording operation of the data; a signal processing circuit which processes the management information and the data; and a control unit which controls a readout of the management information and the additional recording operation of the data, wherein, if the latest Temporary Disc Management Structure (hereinafter, TDMS) cannot be read from the optical disc, the control unit reads out a previously recorded TDMS, acquires a last recorded address (hereinafter, LRA) value from the readout TDMS, detects a boundary address between data recorded area and unrecorded area on the optical disc based on the acquired LRA value, and determines the latest LRA from the detected boundary address, thereby additionally recording data.

According to the optical disc apparatus of the present invention, if the disc management information in TDMS is to be updated, the control unit describes an update reason for the TDMS, and a start address of Temporary Disc Definition Structure (hereinafter, TDDS) in a previously recorded TDMS as Additional Information; and if the latest TDMS cannot be read out of the optical disc but the Additional Information can be read out, the control unit acquires the update reason and the TDDS start address described in the Additional Information, and determines the latest LRA with reference to the acquired information, thereby additionally recording data.

Here, the optical disc includes data recording areas in which the data are recorded and attributes of the data are also recorded in the form of being interleaved among the data, and the control unit describes the TDMS with the updated Additional Information in the data recording areas as data and, at the same time, interleaves and describes duplicately the Additional Information in the data recording areas as a part of the attributes of the data. Also, if the latest TDMS recorded as data cannot be read out of the optical disc, the control unit reads out the duplicately described Additional Information recorded as attributes of data from the data recording areas and determines the latest LRA, thereby additionally recording data.

In addition, according to the optical disc apparatus of the present invention, if TDMS is to be updated, the control unit records duplicately a previously recorded latest Sequential Recording Range Information (hereinafter, SRRI) in the disc management information even though the SRRI is not updated; and reading out the previously recorded SRRI or duplicately recorded SRRI, the control unit determines the latest LRA based on the readout SRRI, thereby additionally recording data.

Another aspect of the present invention provides a disc management information acquisition method during an additional data recording operation on a write-once optical disc, the method includes the steps of: reading a previously recorded Temporary Disc Management Structure (hereinafter, TDMS) if the latest TDMS cannot be read out of the optical disc; acquiring a last recorded address (hereinafter, LRA) from the readout TDMS; detecting, based on the acquired LRA value, a boundary between data recorded area and unrecorded area on the optical disc; and deciding the latest LRA from the detected boundary and thereby, additionally recording data.

According to the disc management information acquisition method of the present invention, when updating TDMS, an update reason for the TDMS and, a start address of Temporary Disc Definition Structure (hereinafter, TDDS) in a previously recorded TDMS, are described in the disc management information as Additional Information; and if the latest TDMS cannot be read out of the optical disc but the Additional Information can be read out, the update reason and the TDDS start address described in the Additional Information are acquired, and the latest LRA is determined with reference to the acquired information, thereby additionally recording data.

Preferably, the optical disc includes data recording areas in which the data are recorded and attributes of the data are also recorded in the form of being interleaved among the data; and the disc management information acquisition method of the present invention further includes the steps of: describing the TDMS with the updated Additional Information in the data recording areas as data and, at the same time, interleaving and describing duplicately the Additional Information in the data recording areas as a part of the attributes of the data; and if the latest TDMS recorded as data cannot be read out of the optical disc, reading out the duplicately described Additional Information recorded as attributes of data from the data recording areas and determining the latest LRA, thereby additionally recording data.

Still another aspect of the present invention provides a disc management information acquisition method during an additional data recording operation on a write-once optical disc, the method includes the steps of: when updating TDMS, recording duplicately a previously recorded latest Sequential Recording Range Information (hereinafter, SRRI) in the disc management information even though the SRRI is not updated; reading out the previously recorded SRRI or duplicately recorded SRRI; and determining the latest LRA based on the readout SRRI, thereby additionally recording data.

Therefore, the present invention is useful for easily recording information additionally onto a write-once optical disc even when the latest disc management information cannot be read out.

### BRIEF DESCRIPTION OF THE DRAWINGS

FIG. 1 is a schematic view illustrating a recording area structure of a write-once optical disc;

FIG. 2 is a schematic view illustrating management information included in TDMA;

FIG. 3 diagrammatically explains the first embodiment of a disc management information acquisition method according to the present invention;

FIG. 4 diagrammatically explains the second embodiment of the disc management information acquisition method according to the present invention;

FIGS. 5A and 5B are flowcharts describing a method for acquiring the latest management information in FIG. 4;

FIG. 6 is diagrammatically explains the third embodiment of the disc management information acquisition method according to the present invention;

FIG. 7 explains a modification of the embodiment in FIG. 6; and

FIG. 8 is a block diagram illustrating an optical disc apparatus according to one embodiment of the present invention.

### DESCRIPTION OF THE PREFERRED EMBODIMENTS

Before getting into details on preferred embodiments of the present invention, it would be helpful to go over the area structure of a targeted disc and terms related to all types of management information stored in those areas.

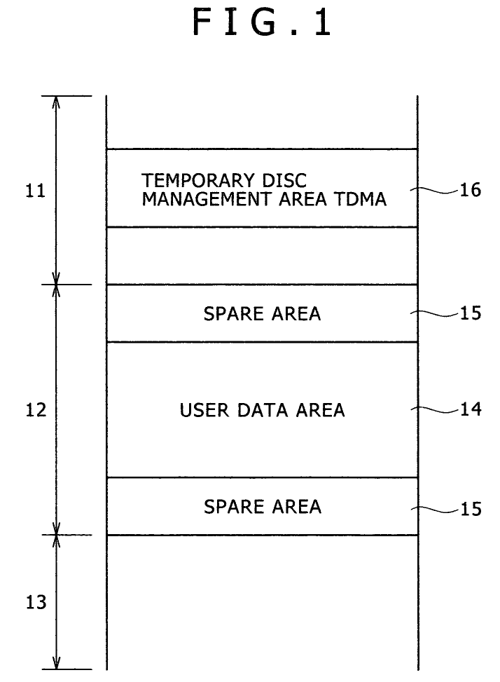

FIG. 1 is a schematic view illustrating a recording area structure of a write-once optical disc such as a Blu-ray disc (BD-R). The write-once optical disc is largely divided into a lead-in area 11, a data area 12, and a lead-out area 13, from an inner circumference. The data area 12 includes a user data area 14 and a spare area 15. The user data area 14 is an area for recording user data, and the spare area 15 is a replacement area for recording data in the case that the user data area 14 has a defect. The lead-in area 11 includes a TDMA (Temporary Disc Management Area) 16. The TDMA 16 is an area where frequently updated recording management information or defect management information are sequentially recorded before the optical disc is finalized, so that those management information can easily be replaced in this area.

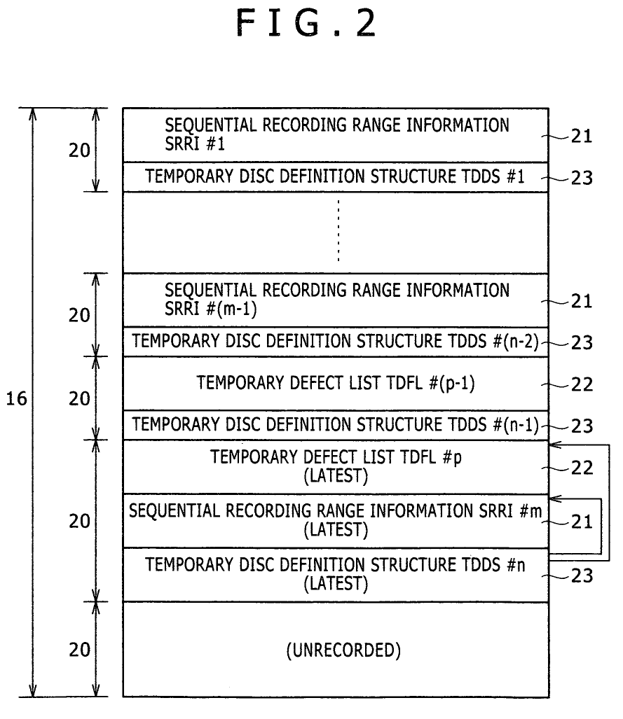

FIG. 2 is a schematic view illustrating management information included in the TDMA 16.

The TDMA 16 is used for updating information over and over in unit of TDMS (Temporary Disc Management Structure) 20. The TDMS 20 includes SRRI (Sequential Recording Range Information), TDFL (Temporary Defect List), and TDDS (Temporary Disc Definition Structure).

The SRRI 21 is the information on data recorded last (that is, the latest recording data), and contains recording start address within the user data area 14, status indicating whether additional recording is available or not, LRA (Last Recorded Address) and the like. An SRR (Sequential Recording Range), for recording user data, is formed in the user data area 14, and user data are sequentially recorded in each SRR. All SRRs have respective SRRIs in TDMS 20.

If data needs to be recorded in the spare area 15 in replacement of the user data area 14 because of a defect therein (replaced recording), the TDFL 22 contains information (defect information) on the replaced recording address.

The TDDS 23 is used for recording information on the latest SRRI start address and the latest TDFL start address (these correspond to the address information (or position information) in the TDMA 16), or information on the size of the TDMA 16 or the spare area 15.

When data needs to be recorded on a write-once optical disc additionally, the apparatus reads the latest TDDS 23 (n) recorded in the latest TDMS 20 (n-th in the drawing), accesses to the latest SRRI 21 (m) and the latest TDFL 22 (p) based on its address to refer to LRA information or defect information therein, and additionally records the data in a proper data area 12. When the additional data recording is completed, the SRRI, TDFL and TDDS information is updated by new information, respectively, and are added to a new TDMS 20 (n+1) on the TDMA 16.

Even though the TDDS 23 is always included in the additionally recorded TDMS 20, the SRRI 21 or the TDFL 22 may or may not be included therein depending on the update circumstances. This is because the SRRI is updated if data is additionally recorded in the user data area 14, and similarly the TDFL is updated if data is recorded in the spare area 15 in replacement. And, address information which points to the latest SRRI and/or the latest TDFL is recorded in the TDDS 23.

Meanwhile, reproduction of data from the write-once optical disc is carried out in block unit. One block is formed of a plurality of sectors. The one-off TDMS 20 records the management information using one or plural blocks, depending on the amount of information to be recorded. For example, if the management information is TDDS+SRRI, the information is received to one block. If the management information is TDDS+TDFL or TDDS+SRRI+TDFL, however, many blocks can be used depending on the amount of information in the TDFL.

Moreover, data is reproduced in block unit, and even if data reproduction in block unit fails, it is possible that data in some sectors within the block can still be read out properly. This partial readout of disc management information is described below.

The following will now explain preferred embodiments of a disc management information acquisition method according to the present invention. In particular, this method is applied when the latest disc management information cannot be read when additionally recording the data.

### Embodiment 1

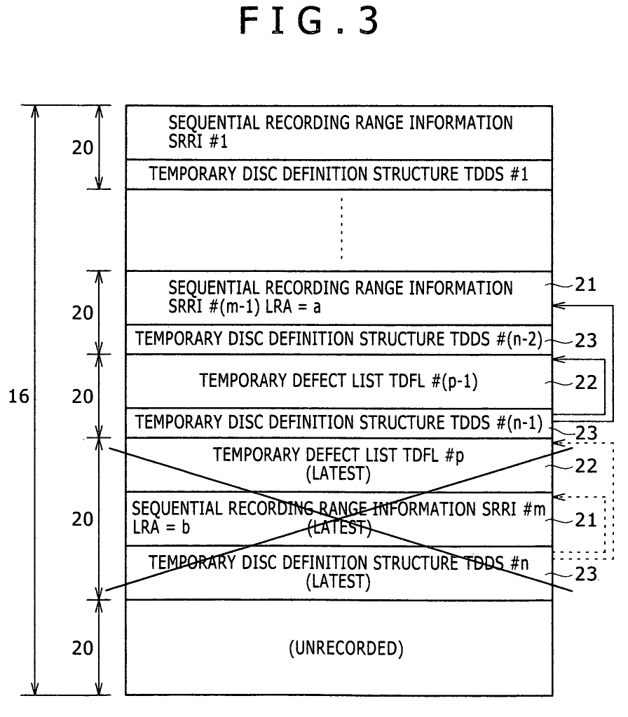

FIG. 3 diagrammatically explains the first embodiment of the disc management information acquisition method according to the present invention. In short, when the latest TDMS cannot be read out, the method in this embodiment acquires other information as a replacement based on the information in a previously recorded TDMS.

In the case that the latest TDMS(n) is unreadable, previously recorded TDMSs starting from the latest TDMS(n) are searched backward until a readable TDMS is found. FIG. 3 illustrates a case in which TDMS(n−1) is read out. Using the address of the TDDS(n−1) in the readable TDMS(n−1), the apparatus accesses to the SRRI(m−1) and the TDFL (p−1) for reference. For convenience, suppose that the apparatus obtained the LRA value of data, e.g., LRA=a, by referring to the SRRI(m−1). However, since this ‘LRA=a’ was obtained referring to the TDMS(n−1), it is not certain whether the value is the latest or not. If there are some data recorded additionally after ‘LRA=a’, it means that the latest LAR value, e.g., LRA=b, must be recorded in the latest SRRI(m) of the latest TDMS(n) which could not be read out.

Therefore, the apparatus needs to search other areas after the LRA=a being acquired, and detects the boundary between the last recorded area and the unrecorded area. The boundary detection can be achieved by comparing the amounts of reflected light from the optical disc, error information of the detected data, etc. In this manner, the latest LRA=b is estimated. Using the estimated LRA=b, the apparatus determines an address for additional data recording and records the data therein.

According to this embodiment, even though the latest TDMS(n) cannot be read out, the apparatus can estimate and acquires other latest information as a replacement by referring the previous, readable TDMS, thereby resolving the readout failure problem.

### Embodiment 2

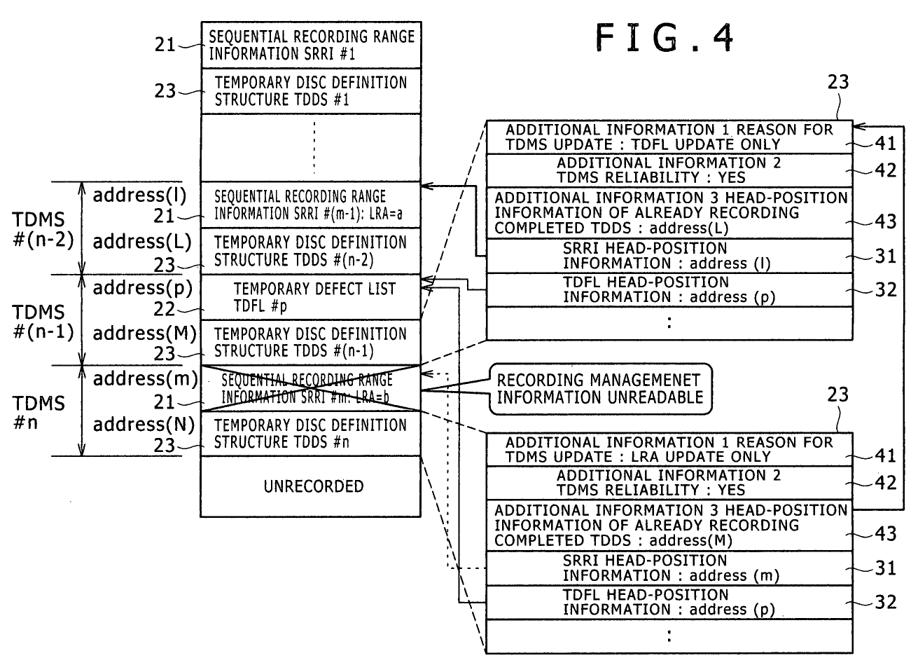

FIG. 4 diagrammatically explains the second embodiment of the disc management information acquisition method according to the present invention. In this embodiment, when TDMS is updated, new information for search (hereinafter referred to as additional information) is added and recorded in the TDDS. That is, for recording TDMS(n), the value of an address 31 (address m) of the latest SRRI(m) and the value of an address 32 (address p) of the latest TDFL(p) are conventionally recorded in the TDDS 23 (n), and moreover, the additional information which includes:

(1) Reason for updating new TDMS “Additional Information 1” (reference numeral 41);

(2) Information that indicates whether the new TDMS was updated based on accurate and reliable information “Additional Information 2” (reference numeral 42); and

(3) TDDS start address in the previously recorded TDMS “Additional Information 3” (reference numeral 43); are also recorded in the TDDS 23 (n).

The TDDS(n) in FIG. 4 shows the contents of additional information describing in a case where updating the LRA of the SRRI (updated from ‘a’ to ‘b’) occurs due to additional data recording. In other words, “Additional Information 1” describes that a new TDMS(n) being recorded additionally is for updating the LRA of the SRRI. “Additional Information 2” describes that a new TDMS(n) is updated based on accurate and reliable information. Lastly, “Additional Information 3” provides a start address (the address value M in this case) of the TDDS(n−1) in the previous recorded TDMS(n−1).

By recording the additional information, it is possible that the latest TDMS(n) can be recovered although its readout failed at first. This is because the management information is recorded in block unit, and even if data reproduction in block unit fails, it is possible that some sectors (which is the sub-unit of the block) can still be read out properly. And if the above-described additional information is included in readable sector, the apparatus can read out or estimate the latest SRRI (LRA) or the latest TDFL.

Referring again to FIG. 4, suppose that although the SRRI(m) in the TDMS(n) could not be read out, the additional information portion of the TDDS(n) could be read out properly. Since the latest SRRI(m) cannot be read out, the apparatus cannot find out the latest LRA=b directly. However, from the Additional Information 1 of the TDMS(n) the apparatus learns that the TDMS(n) was updated because of the updated LRA, and from the Additional Information 3 the apparatus learns the head address (address M) of the previous TDDS(n−1). Therefore, the apparatus is capable of reading the previous ‘LRA=a’ from the previous SRRI(m−1), and keeps searching from this point to estimate the latest LRA=b.

Afterwards, the apparatus determines an address for additional data recoding by “estimating” LRA=b, and records data additionally. In this case, the Additional Information 2 of the TDMS(n+1) being recorded additionally describes an object of ‘estimating’ the LRA=b, indicating that it would be ‘confirmed’ if TDMS(n) could be read out properly in future.

The above-described case is only one example. Thus, the procedure of acquiring the latest management information changes, depending on the contents in Additional Information. Other acquisition methods and their procedures are described below.

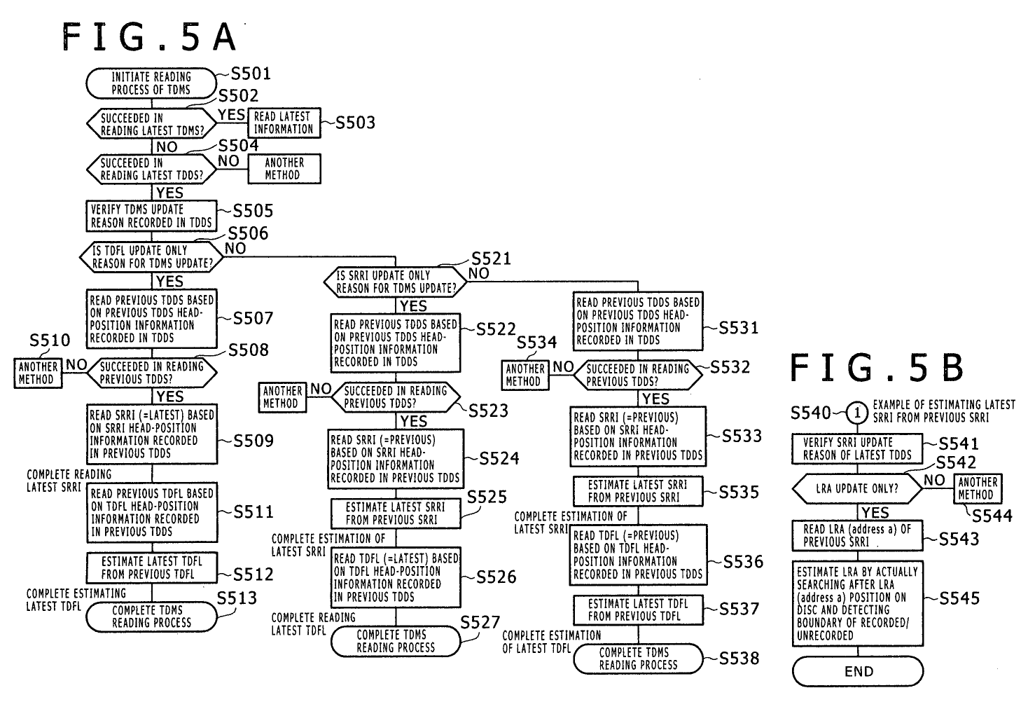

FIG. 5 is a flowchart describing a method for acquiring the latest management information (SRRI (LRA), TDFL) according to one embodiment of the present invention. In detail, FIG. 5A is a flowchart describing the method overall, and FIG. 5B is a flowchart describing particularly the SRRI estimation step in FIG. 5A.

The apparatus initiates the readout of the TDMS (S501), and proceeds with its search using the Additional Information in the case that it failed the readout of the latest TDMS(n) (No in S502), especially in the case that it succeeded the readout of the latest TDDS(n) (Yes in S504).

While referring to the Additional Information 1 described in the TDDS(n) (S505), if the TDMS was updated just because the TDFL had been updated (Yes in S506), the apparatus proceeds to the step S507 else, the apparatus proceeds to the step S521. If the TDMS was updated just because the SRRI had been updated (Yes in S521), the apparatus proceeds to the step S522. Meanwhile, if the TDMS was updated because both TDFL and SRRI had been updated, the apparatus proceeds to the step S531.

In the case that only the TDFL had been updated, the apparatus reads out the previous TDDS(n−1) referring to the Additional Information 3 (S507). If this readout succeeds (Yes in S508), the apparatus reads out the SRRI from the address information of the SRRI described in the TDDS(n−1). In this case, since the SRRI is not updated, the apparatus judges the readout SRRI as the latest SRRI (S509). Also, the apparatus judges the LRA value described in the SRRI as the latest LRA value. In the meantime, the apparatus reads out the TDFL from the address information of the TDFL described in the TDDS(n−1). In this case, since the TDFL is updated, the readout TDFL is actually the previous TDFL (S511), not the latest. Thus, the apparatus should search the disc from this point, and estimates the latest TDFL (S512). In this manner, the readout of the TDMS ends (S513).

Next, in the case that only the SRRI had been updated, the apparatus reads out the previous TDDS(n−1) referring to the Additional Information 3 (S522). If this readout succeeds (Yes in S523), the apparatus reads out the SRRI from the address information of the SRRI described in the TDDS(n−1). In this case, since the SRRI is updated, the readout SRRI is actually the previous SRRI (S524), not the latest. Thus, the apparatus should search the disc from this point, and estimates the latest SRRI (S525). On other hand, the apparatus reads out the TDFL from the address information of the TDFL described in the TDDS(n−1). In this case, since the TDFL is not updated, the apparatus judges the readout TDFL as the latest TDFL (S526). In this manner, the readout of the TDMS ends (S527).

Moreover, in the case that both TDFL and SRRI had been updated, the apparatus reads out the previous TDDS(n−1) referring to the Additional Information 3 (S531). If this readout succeeds (Yes in S532), the apparatus reads out the SRRI from the address information of the SRRI described in the TDDS(n−1). In this case, since the SRRI is updated, the readout SRRI is actually the previous SRRI (S533), not the latest. Thus, the apparatus should search the disc from this point, and estimates the latest SRRI (S535). Meanwhile, the apparatus reads out the TDFL from the address information of the TDFL described in the TDDS(n−1). In this case, since the TDFL is updated, the readout TDFL is actually the previous TDFL (S536), not the latest. Thus, the apparatus should search the disc, and estimates the latest TDFL (S537). In this manner, the readout of the TDMS ends (S538).

FIG. 5B diagrammatically describes the SRRI estimation step from the previous SRRI (S525 and S535) in the flowchart of FIG. 5A.

First, the apparatus refers to the Additional Information 1 described in the TDDS(n), especially the reason for the SRRI update. If it turns out that the SRRI was updated only because the LRA had been updated (Yes in S542), the apparatus reads out the previous LRA (=a) from the previous, readout SRRI (S543). The apparatus actually searches areas on the disc after the LRA=a address to detect the boundary between the recorded areas and the unrecorded areas, and estimates its position as the latest LRA (=b) (S545).

According to this embodiment, the apparatus records the Additional information in the TDMS and refers it for a search. In this way, although the latest TDMS may not be read out properly, the apparatus can acquire or estimate desired latest information very quickly. Especially when the update reason lies in the TDFL update only, the SRRI (LRA) the apparatus obtained by referring to the Additional Information is actually the latest information it desired, whereby the readout failure of the TDMS can be naturally resolved without any obstacle. In addition, when the apparatus reads out the previous TDDS, its head address is also given. This also helps the apparatus quickly access, spending a smaller amount of time for detection.

In this embodiment, the Additional Information is assumed to be described in the TDDS area within the TDMS, but it can also be recorded duplicately in other areas. For instance, the information may be recorded in BIS (Burst Indicator Subcode) area on the BD disc. The BIS area is a data recording area in which attributes of the user data is to be recorded, being interleaved among recording user data. The BIS is recorded (read out) inevitably and synchronously with recording (reading out) the user data. Hence, if the Additional Information is duplicately recorded in the BIS area, the apparatus can record (read out) the Additional Information, requiring no more disc capacity or spending no more processing time, than the amount of those required for recording (reading out) the user data. Moreover, since the BIS area has its own error correcting system apart from the user data, although the TDMS recorded in the user data cannot be read out, it is possible that the information recorded in the BIS area can be read out properly and using this information, the additional data recording can be carried out speedily.

### Embodiment 3

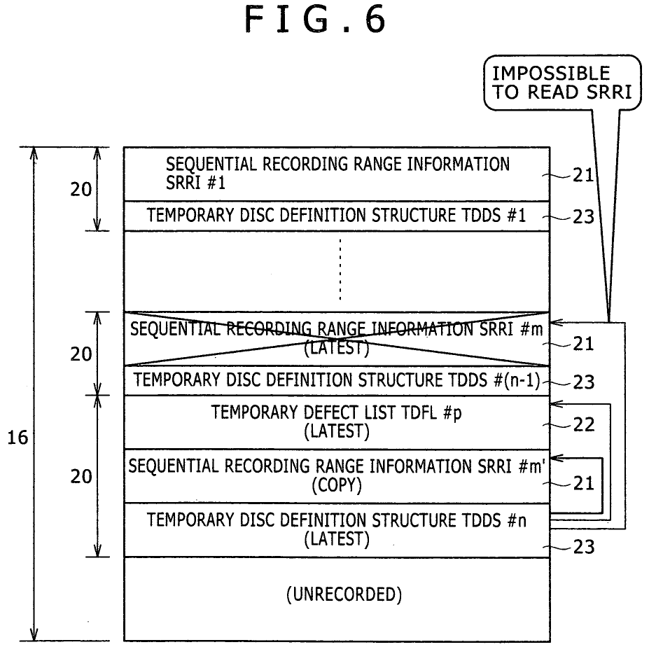

FIG. 6 diagrammatically explains the third embodiment of the disc management information acquisition method according to the present invention. According to this embodiment, the SRRI is described every time the TDMS is recorded additionally. That is to say, when only the TDFL is updated, the SRRI is described duplicately together with the TDFL.

Referring to FIG. 6, additional recording of TDMS(n) is caused just by the update of the TDFL. However, with the updated TDFL(p), the SRRI(m) having been described in the previous TDMS(n−1) area is copied again, and is described as SRRI(m′). Thus, the SRRI(m) and the SRRI(m′) are the same and the latest information. In addition, address information of both SRRI(m) and SRRI(m′) are described in the TDDS(n) within the TDMS(n).

According to this configuration, even though the original SRRI(m) cannot be read out, the apparatus can still read out its twin, SRRI(m′), as a replacement by referring to the TDMS(n). At any rate, the latest SRRI is properly obtained and the readout failure is resolved. Besides, since the SRRI(m′) is the latest SRRI, its readout can be tried first.

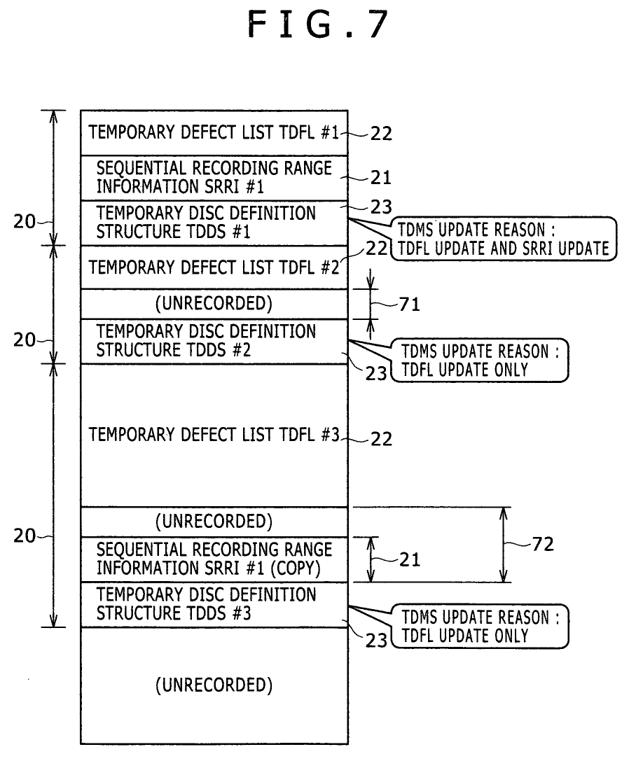

FIG. 7 is a modification of the embodiment in FIG. 6, in which there is a limit in the case that the SRRI is duplicately described. Duplicately describing the copied SRRI implies that the SRRI is not to be updated (that is, only the TDFL is updated). Therefore, the SRRI is recorded additionally in a block containing the TDFL and the TDDS. This embodiment sets a limitation that the SRRI can be recorded additionally only if the number of blocks used is not increased in spite of additional recordings of the SRRI.

In FIG. 7, since the TDMS 2 and the TDMS 3 are for updating only the TDFL, the SRRI is supposed to be described duplicately. In the case of the TDMS 2, however, the apparatus does not duplicate the SRRI in the TDMS 2 because the capacity of an unrecorded area 71 where the copy of the SRRI 1 is to be recorded is not sufficient. That is, the duplication of the SRRI 1 in the TDMS 2 causes the number of blocks used for description of the TDMS 2 to be doubled from one block to two blocks. Meanwhile, in the case of the TDMS 3, since the capacity of the unrecorded area 72 is sufficient for copying and recording the SRRI 1, the apparatus can describe the SRRI 1 duplicately. Needless to say, the number of blocks used remains unchanged, e.g., two, despite the duplicated descriptions.

According to this embodiment, because the duplicated descriptions of the SRRI occupy the unrecorded data area in the TDMS, the extra TDMA areas are not wasted and the disc capacity can be utilized very effectively. Thus, the possibility of obtaining the latest SRRI is increased in this case, too.

### Embodiment 4

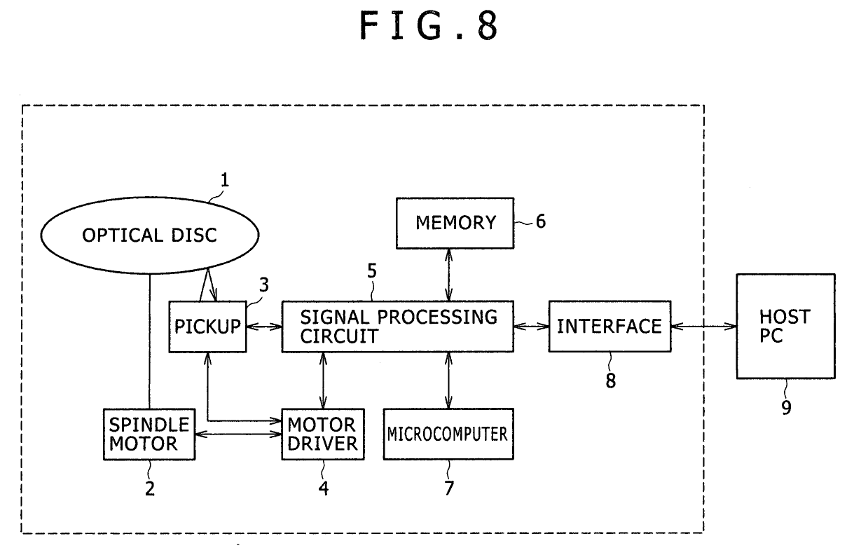

FIG. 8 is a block diagram illustrating an optical disc apparatus according to one embodiment of the present invention. In this apparatus, a write-once optical disc 1 is rotated by a spindle motor 2, and a pickup 3 irradiates a laser beam emitted from a semiconductor laser onto a recording surface of the optical disc 1, and records or reproduces data onto or from the disc. The pickup 3 moves to a desired track on the optical disc by means of a thread unit which is not described in the FIG. 8. A motor driver 4 provides a driving signal to the spindle motor 2 or the thread unit.

A signal processing circuit 5 processes a readout signal from the optical disc 1, acquires disc management information and, at the same time, reproduces data. The data thus reproduced is temporarily stored in a memory 6, and is transferred to a host device 9 such as a PC through an interface 8. On the other hand, the recording data transferred from the host device 9 is temporarily stored in the memory 6, and is converted to an appropriate recording signal by the signal processing unit 5. The pickup 3 records data (additional recording) on the optical disc 1 and, at the same time, updates and records the disc management information (additional recording). A microcomputer 7 determines a data recording address (additional recording address) based on the readout disc management information from the optical disc, and with this data recording (additional recording), it also updates and records the disc management information. Moreover, the microcomputer 7 controls the overall operation of the apparatus, including the rotation control of the spindle motor 2 and the position control of the pickup 3.

According to the apparatus of this embodiment, when an additional data record command is issued from the host device 9, the signal processing circuit 5 and the microcomputer 7 read out the latest TDMS 20 from the TDMA 16 of the optical disc 1, and acquires the latest SRRI 21 and/or the latest TDFL 22. If the readout of this information fails, the apparatus acquires or estimates other latest information as a replacement, following the management information acquisition method described in the embodiment 1, 2 or 3. Using the management information thus obtained, the apparatus additionally records new data in an appropriate address in the data area 12. Once the data recording operation is completed, the apparatus updates the latest TDMS 20 and additionally records it in the TDMA 16. In such case, the Additional Information aforementioned in the embodiments 2 and 3 is added and the SRRI is also described duplicately.

In conclusion, even when the latest disc management information cannot be read out directly from the disc, the optical disc apparatus of this embodiment can easily acquire the replacement management data and execute the additional recording operation.

What is claimed is:

1. An optical disc apparatus for use in additional data recording on a write-once optical disc, the apparatus comprising:
a spindle motor which rotates the optical disc;
a pickup which irradiates a laser beam onto the optical disc, reads out disc management information, and thereby executes an additional recording operation of the data;
a signal processing circuit which processes the management information and the data; and
a control unit which controls a readout of the management information and the additional recording operation of the data,
wherein, if the latest Temporary Disc Management Structure (hereinafter, TDMS) cannot be read from the optical disc, the control unit reads out a previously recorded TDMS, acquires the last recorded address (hereinafter, LRA) value from the readout TDMS, detects a boundary address between data recorded areas and unrecorded areas on the optical disc based on the acquired LRA value, and determines the latest LRA from the detected boundary address, thereby additionally recording data.

2. An optical disc apparatus for use in additional data recording on a write-once optical disc, the apparatus comprising:
a spindle motor which rotates the optical disc;
a pickup which irradiates a laser beam onto the optical disc, reads out disc management information, and thereby executes an additional recording operation of the data;
a signal processing circuit which processes the management information and the data; and
a control unit which controls a readout of the management information and the additional recording operation of the data,
wherein, if the disc management information in the TDMS is to be updated, the control unit describes an update reason for the TDMS, and a start address of Temporary Disc Definition Structure (hereinafter, TDDS) in a previously recorded TDMS as Additional Information; and
if the latest TDMS cannot be read out of the optical disc but the Additional Information can be read out, the control unit acquires the Additional Information, and determines the latest LRA with reference to the acquired information, thereby additionally recording data.

3. The optical disc apparatus according to claim 2, wherein, if the update reason in the Additional Information does not include the update of Sequential Recording Range Information (hereinafter, SRRI), the control unit takes the LRA, which is acquired by referring to the TDDS start address described in the Additional Information, as the latest one.

4. The optical disc apparatus according to claim 2,
wherein the optical disc comprises data recording areas in which the data are recorded and attributes of the data are also recorded in the form of being interleaved among the data;
the control unit describes the TDMS with the updated Additional Information in the data recording areas as data and, at the same time, interleaves and describes duplicately the Additional Information in the data recording areas as a part of the attributes of the data; and
if the latest TDMS recorded as data cannot be read out of the optical disc, the control unit reads out the duplicately described Additional Information recorded as attributes of data from the data recording areas and determines the latest LRA, thereby additionally recording data.

5. An optical disc apparatus for use in additional data recording on a write-once optical disc, the apparatus comprising:
a spindle motor which rotates the optical disc;
a pickup which irradiates a laser beam onto the optical disc, reads out disc management information, and thereby executes an additional recording operation of the data;
a signal processing circuit which processes the management information and the data; and
a control unit which controls a readout of the management information and the additional recording operation of the data,
wherein, if TDMS is to be updated, the control unit describes duplicately a previously recorded latest SRRI in the disc management information even though the SRRI is not updated; and
the control unit, reading out the previously recorded SRRI or duplicately recorded SRRI, determines the latest LRA based on the readout SRRI, thereby additionally recording data.

6. A disc management information acquisition method during an additional data recording operation on a write-once optical disc, the method comprising the steps of:
reading a previously recorded Temporary Disc Management Structure (hereinafter, TDMS) if the latest TDMS cannot be read out of the optical disc;
acquiring a last recorded address (hereinafter, LRA) from the readout TDMS;
detecting, based on the acquired LRA value, a boundary between data recorded areas and unrecorded areas on the optical disc; and
deciding the latest LRA from the detected boundary and thereby, additionally recording data.

7. A disc management information acquisition method during an additional data recording operation on a write-once optical disc, the method comprises the steps of:
when updating TDMS, describing in the disc management information an update reason for the TDMS, and a start address of Temporary Disc Definition Structure (hereinafter, TDDS) in a previously recorded TDMS as Additional Information; and
if the latest TDMS cannot be read out of the optical disc but the Additional Information can be read out, acquiring the update reason and the TDDS start address described in the Additional Information, and determining the latest LRA with reference to the acquired information, thereby additionally recording data.

8. The disc management information acquisition method according to claim 7, further comprising the step of:
if the update reason in the Additional Information does not include the update of Sequential Recording Range Information (hereinafter, SRRI), taking the LRA, which is acquired by referring to the TDDS start address described in the Additional Information, as the latest one.

9. The disc management information acquisition method according to claim 7,
wherein the optical disc comprises data recording areas in which the data are recorded and attributes of the data are also recorded in the form of being interleaved among the data; and
the method further comprises the steps of:
describing the TDMS with the updated Additional Information in the data recording areas as data and, at the same time, interleaving and describing duplicately the Additional Information in the data recording areas as a part of the attributes of the data; and
if the latest TDMS recorded as data cannot be read out of the optical disc, reading out the duplicately described Additional Information recorded as attributes of data from the data recording areas and determining the latest LRA, thereby additionally recording data.

10. A disc management information acquisition method during an additional data recording operation on a write-once optical disc, the method comprising the steps of:
when updating TDMS, recording duplicately a previously recorded latest SRRI in the disc management information even though the SRRI is not updated;
reading out the previously recorded SRRI or duplicately recorded SRRI; and
determining the latest LRA based on the readout SRRI, thereby additionally recording data.

11. The disc management information acquisition method according to claim 10, wherein the duplicate recording of the previously recorded latest SRRI is limited to a case in which the number of blocks using a corresponding TDMS as a result of the duplicate recording operation of the SRRI is not increased.
